(19) United States
(12) Patent Application Publication
(10) Pub. No.: US 2023/0307200 A1
(43) Pub. Date: Sep. 28, 2023

(54) ELECTRIC DEVICE

(71) Applicant: FUJI ELECTRIC FA COMPONENTS & SYSTEMS CO., LTD., Saitama (JP)

(72) Inventors: Masashi SEKIYA, Kawagoe-city (JP); Kouetsu TAKAYA, Kawagoe-city (JP); Shouta KIKUCHI, Kawagoe-city (JP)

(73) Assignee: FUJI ELECTRIC FA COMPONENTS & SYSTEMS CO., LTD., Saitama (JP)

(21) Appl. No.: 18/172,029

(22) Filed: Feb. 21, 2023

(30) Foreign Application Priority Data
Mar. 24, 2022 (JP) 2022-048250

(51) Int. Cl. H01H 50/02; H01H 50/54; H01H 50/44

(52) U.S. Cl. CPC H01H 50/02; H01H 50/54; H01H 50/44

(57) ABSTRACT

There is provided an electric device configured to allow easy replacement of one or more electric components housed in a first frame and a second frame and suppressing relative displacement of the first frame and the second frame to enhance reliability. A bulging wall member of a body frame is formed by a bulging wall member of the first frame and a bulging wall member of the second frame, both members being contiguous in a Z-direction. A relative displacement suppression mechanism configured to suppress relative displacement of an X-direction and a Y-direction is provided in an area in which the bulging wall member and the bulging wall member are contiguous.

### CROSS REFERENCE TO RELATED APPLICATIONS AND INCORPORATION BY REFERENCE

This application claims benefit of priority under 35 USC 119 based on Japanese Patent Application No. 2022-048250 filed on Mar. 24, 2022, the entire contents of which are incorporated by reference herein.

### TECHNICAL FIELD

The present disclosure relates to a technology efficiently applicable to an electric device including a first frame and a second frame each housing one or more electric components.

### BACKGROUND ART

An electromagnetic contactor as an electric device includes a body frame housing a contact unit and an electromagnet unit. The body frame includes a first frame and a second frame opposed to each other and a connecting mechanism to connect together the first frame and the second frame.

PTL 1 and PTL 2 disclose an electromagnetic contactor including a snap-fit mechanism as a connecting mechanism. The snap-fit mechanism described in PTL 1 connects together the first frame and the second frame by way of fitting between a fitting member provided in a hook member of the first frame and a fitting projection provided in the second frame.

In addition, the snap-fit mechanism described in PTL 2 connects together an upper case (the first frame) and a lower case (the second frame) by way of fitting between an engaging projection provided in the upper case and a projection receptacle provided in an elastic plate member of the lower case.

### CITATION LIST

### Patent Literature

PTL 1: WO 2015/177961 A1
PTL 2: JP H07-312159 A

### SUMMARY OF INVENTION

### Technical Problem

An electromagnetic contactor requires replacement of an electric component such as an electromagnetic coil in accordance with the type of a power supply used by a customer. It is thus preferable to connect together and disconnect the first frame and the second frame in a simple fashion without using a tool. Also, to provide a reliable electromagnetic contactor, it is necessary to completely suppress relative displacement between the first frame and the second frame connected with any electric component replaced.

The present disclosure has been accomplished in view of the above-mentioned technical problems, and it is an object of the present disclosure to provide an electric device allowing easy replacement of an electric component housed in the first frame and the second frame, as well as suppressing relative displacement between the first frame and the second frame thus enhancing the reliability.

### Solution to Problem

In order to achieve the above-described object, according to an aspect of the present disclosure, there is provided an electric device including: a first frame and a second frame each configured to house one or more electric components by arranging an open end of each of the frames opposed to each other in a first direction; and a relative displacement suppression mechanism configured to detachably connect together the first frame and the second frame, to suppress relative displacement to a second direction and a third direction orthogonal to the first direction and orthogonal to each other in the same plane; wherein on each of the first frame and the second frame there are arranged, as opposed to each other, a pair of first bulging walls extending in the second direction with a wall surface oriented backwards to each other in the third direction, and bulging wall members having a second bulging wall with a wall surface oriented in the second direction at the tip of the pair of first bulging walls, and the relative displacement suppression mechanism comprises: a first fixing member formed on the second bulging wall of the first frame; a second fixing member formed on the second bulging member of the second frame overlapping the first fixing member in the first direction; a third fixing member formed on at least one of the pair of first bulging walls of the first frame; and a connecting member configured to engage with the first to third fixing members by moving from the second frame side to the first frame side.

### Advantageous Effects of Invention

According to the electric device of the present disclosure, it is possible to allow easy replacement of an electric component housed in the first frame and the second frame, as well as to suppress relative displacement between the first frame and the second frame thus enhancing the reliability.

### BRIEF DESCRIPTION OF DRAWINGS

FIG. 1 is a perspective view of an electromagnetic contactor according to an embodiment of the present disclosure;

FIG. 2 is a cross-sectional view of the internal structure of the electromagnetic contactor;

FIGS. 3A and 3B illustrate a first fixing member, a second fixing member, and a third fixing member formed on a bulging wall member of a first frame and a second frame constituting a relative displacement suppression mechanism according to the present disclosure;

FIG. 4 illustrates the first fixing member and the third fixing member formed on a bulging wall member of the first frame;

FIG. 5A is a perspective view of a connecting member constituting the relative displacement suppression mechanism according to the present disclosure;

FIG. 5B illustrates the connecting member of FIG. 5A as viewed from the front;

FIG. 6A is a cross-sectional view of a main section illustrating a connected state of the connecting member;

FIG. 6B is a cross-sectional view of the main section illustrating a temporarily held state of the connecting member;

FIG. 7 is a cross-sectional view of a main member illustrating the connected state of the connecting member;

FIG. 8A illustrates a state in which a stopper projection formed on the connecting member is engaged, in the connected state, with a projection engaging member provided in the first frame;

FIG. 8B illustrates a state in which the stopper projection of the connecting member is engaged, in the temporarily held state, with a stopper member of the second frame;

FIG. 9A illustrates a state in which a click projection formed on the connecting member is engaged, in the connected state, with a connecting recess formed in the first fixing member; and

FIG. 9B illustrates a state in which the click projection of the connecting member is engaged, in the temporarily held state, with the temporarily holding recess formed in the second fixing member.

### DESCRIPTION OF EMBODIMENTS

Embodiments of the present disclosure will now be described with reference to the attached drawings.

Throughout the drawings, identical or similar members are labeled with the same or similar signs. It should be noted, however, that the drawings are schematic, and the relationship between a thickness and a planar dimension, the ratio in thickness between layers, and the like are different from real ones. Thus, concrete thicknesses and dimensions should be judged in consideration of descriptions below. Needless to say, the drawings include members with mutually different relations or ratios of dimensions.

In addition, embodiments described below illustrate, by way of example, a device or a method for embodying technical concepts of the present invention, and the technical concepts of the present invention do not specifically limit the material, shape, structure, arrangement, and the like of a component to those described below. Various changes may be made to the technical concepts of the present invention within the technical scope defined by the claims set forth in the appended claims.

An X-direction and a Y-direction described in the drawings are orthogonal to each other in the same plane, and a Z-direction is a direction orthogonal to the X-direction and Y-direction. Further, the Z-direction corresponds to the first direction described in the present disclosure, the X-direction to the second direction described in the present disclosure, and the Y-direction to the third direction described in the present disclosure.

In the embodiments presented below, a case will be described in which the present disclosure is applied to an electromagnetic contactor as an electric device. The present invention is not limited to an electromagnetic contactor illustrated in the following embodiments, but can also be applied to other electric devices.

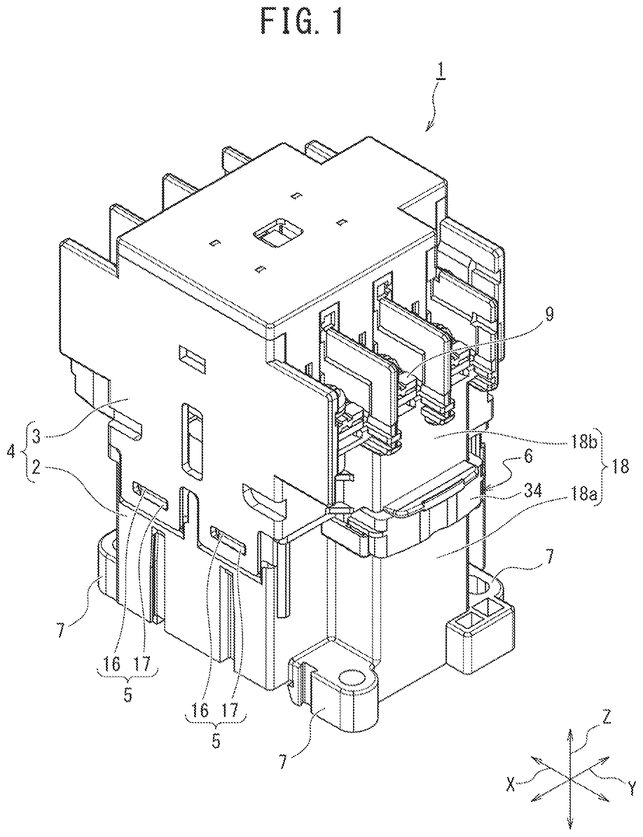

FIG. 1 illustrates an appearance of an electromagnetic contactor 1. The electromagnetic contactor 1 includes a body frame 4 composed of a first frame 2 and a second frame 3, a snap-fit mechanism 5 connecting together the first frame 2 and the second frame 3 from the Z-direction, and a relative displacement suppression mechanism 6 for suppressing relative displacement, in the X-direction and the Y-direction, of the first frame 2 and the second frame 3 connected together.

The first frame 2 is composed of a bottomed cylinder in which a side designed to connect to the second frame 3 and having a side wall of a substantially square cylindrical shape is open and an opposite side of the side wall is closed by a bottom wall member (not illustrated), and a mounting plate member 7 is formed at four corners of the bottom member.

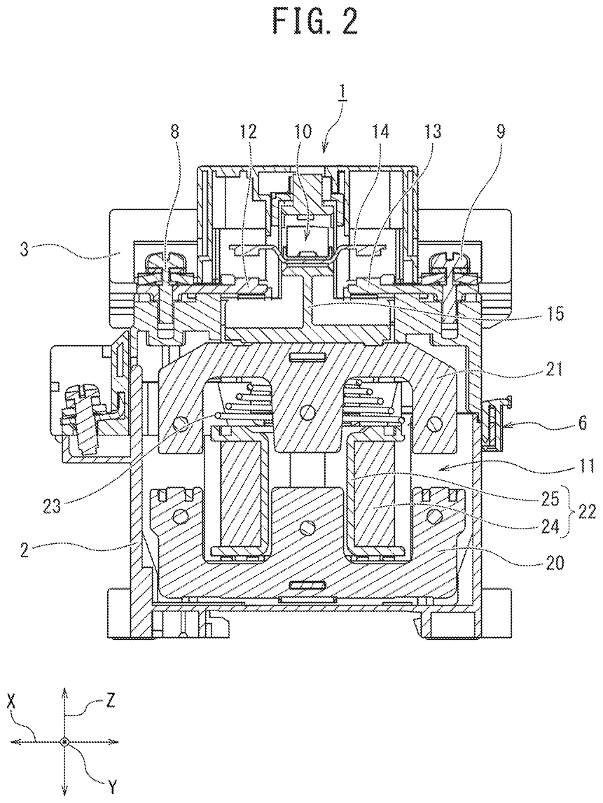

The second frame 3 also includes a side wall having substantially the same square cylindrical shape as the first frame 2 and a side designed to connect to the first frame 2 is open. On the opposite side of the side wall are provided a primary side terminal member 8 (see FIG. 2) and a secondary side terminal member 9.

FIG. 2 illustrates an internal structure of the electromagnetic contactor 1, in which the contact unit 10 is housed in the second frame 3, and an electromagnet unit 11 for driving the contact unit 10 is housed in the first frame 2.

The contact unit 10 includes a pair of fixed contact pieces 12 and 13 in which the primary side terminal member 8 and the secondary side terminal member 9 described above are integrally provided, a movable bridge-type contact piece 14 in which a movable contact is arranged separably with respect to fixed contacts of the pair of fixed contact pieces 12 and 13, and a movable contact support 15 for holding the movable contact piece 14. The pair of fixed contact pieces 12 and 13 and the movable contact piece 14 are arranged three in a row, side by side, in the Y-direction as compatible with a three-phase AC electric circuit.

The electromagnet unit 11 includes a fixed iron core 20 and a movable iron core 21, an electromagnetic coil 22, and a return spring 23. The fixed iron core 20 and the movable iron core 21 are arranged to cause their respective contact surfaces to face each other. The electromagnetic coil 22 generates a magnetic field to cause the fixed iron core 20 to absorb the movable iron core 21 by way of an electromagnetic force. The electromagnetic coil 22 has a winding 24 and a bobbin 25. The return spring 23 is a coil spring configured to bias the movable iron core 21 in a direction away from the fixed iron core 20. The movable contact piece 14 is fixed to one end side in the Z-direction of the movable contact support 15. The other end side in the Z-direction of the movable contact support 15 is fixed to the back surface member, on the opposite side from the leg side, of the movable iron core 21. The movable contact piece 14 moves in the Z-direction along with the movement of the movable iron core 21 in the Z-direction, and the pair of fixed contact pieces 12 and 13 and the movable contact piece 14 are separated from each other in a released state in which the fixed iron core 20 and the movable iron core 21 are separated from each other, and are in contact with each other in a closed state in which the fixed iron core 20 and the movable iron core 21 are in contact with each other.

Returning to FIG. 1, the snap-fit mechanism 5 connecting together the first frame 2 and the second frame 3 from the Z-direction includes a fitting hole 16 provided open to a side wall, on the side to connect to the first frame 2, of the second frame 3, and a fitting projection 17 formed on a side wall, on the side to connect to the first frame 3, of the first frame 2 and fits into the fitting hole 16 by relatively moving the first frame 2 and the second frame 3 in the Z-direction. Although two snap-fit mechanisms 5 are provided on one side in the Y-direction of the first frame 2 and the second frame 3 in FIG. 2, the snap-fit mechanisms 5 are provided also on the other side in the Y-direction (not illustrated).

As illustrated in FIG. 1, the body frame 4 includes a bulging wall member 18 bulging toward one side in the

X-direction, and the bulging wall member 18 is formed by a bulging wall member 18a of the first frame 2 and a bulging wall member 18b of the second frame 3, both members being contiguous in the Z-direction. A relative displacement suppression mechanism 6 is provided in an area in which the bulging wall member 18a and the bulging wall member 18b are contiguous.

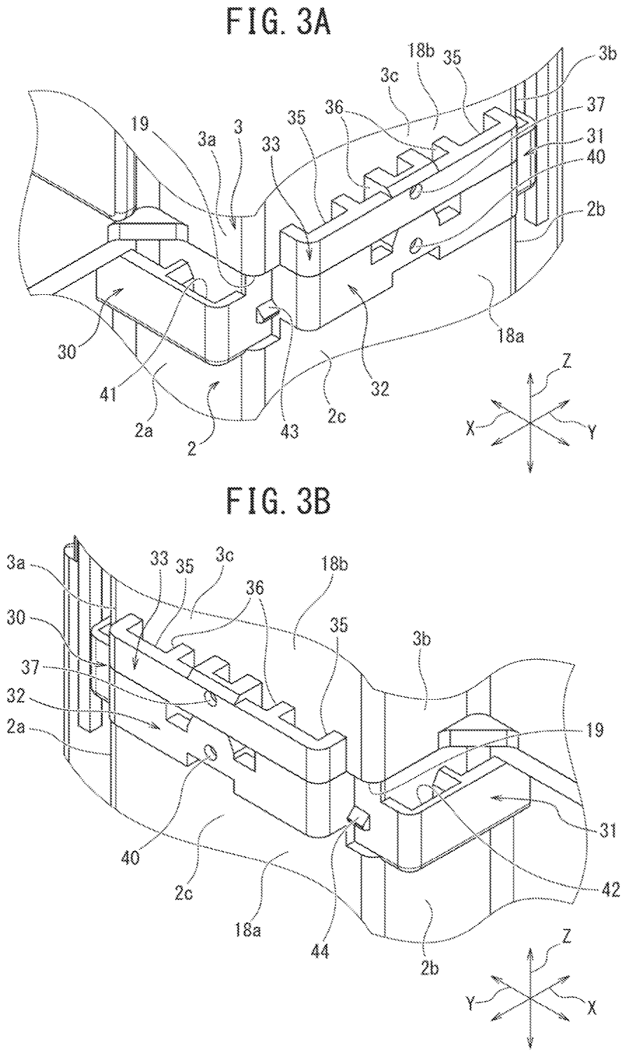

As illustrated in FIGS. 3A and 3B, the bulging wall member 18a of the first frame 2 is composed of a bulging wall 2a with a wall surface facing one side in the Y-direction, a bulging wall 2b with a wall surface facing the other side in the Y direction, and a bulging wall 2c formed contiguously with the bulging walls 2a, 2b and having a wall surface facing one side in the X-direction. The bulging wall member 18b of the second frame 3 is composed of a bulging wall 3a with a wall surface facing one side in the Y-direction, a bulging wall 3b with a wall surface facing the other side in the Y-direction, and a bulging wall 3c formed contiguously with the bulging walls 3a, 3b and having a wall surface facing one side in the X-direction. The bulging walls 2a, 3a and the bulging walls 2b, 3b are flush with each other and contiguous in the Z-direction. The bulging wall 2c of the first frame 2 is recessed toward one side in the X-direction from the bulging wall 3c of the second frame 3, and the end surface of the bulging wall 3c forms a stopper member 19 described later.

As illustrated in FIGS. 3A and 3B, the relative displacement suppression mechanism 6 includes: a first frame fixing member 30 formed on the bulging wall 2a of the first frame 2; a first frame fixing member 31 formed on the bulging wall 2b of the first frame 2; a first frame fixing member 32 formed on the bulging wall 2c of the first frame 2; and a second frame fixing member 33 formed on the bulging wall 3c of the second frame 3 and overlapping in the Z-direction with respect to the first frame fixing member 32; and, as illustrated in FIG. 1, a connecting member 34 arranged across the bulging wall member 18a of the first frame 2 and the bulging wall member 18b of the second frame 3, and detachably mounted on the first frame fixing members 30 to 32 and the second frame fixing member 33.

As illustrated in FIG. 3A, in the second frame fixing member 33 there are formed a pair of insertion sections 35 penetrating in the Z-direction while separated from each other in the Y-direction, and between the pair of insertion sections 35 there are formed a pair of insertion sections 36 penetrating in the Z-direction while separated from each other in the Y-direction. In an outer wall facing one side in the X direction of the second frame fixing member 33 is formed a temporarily holding recess 37.

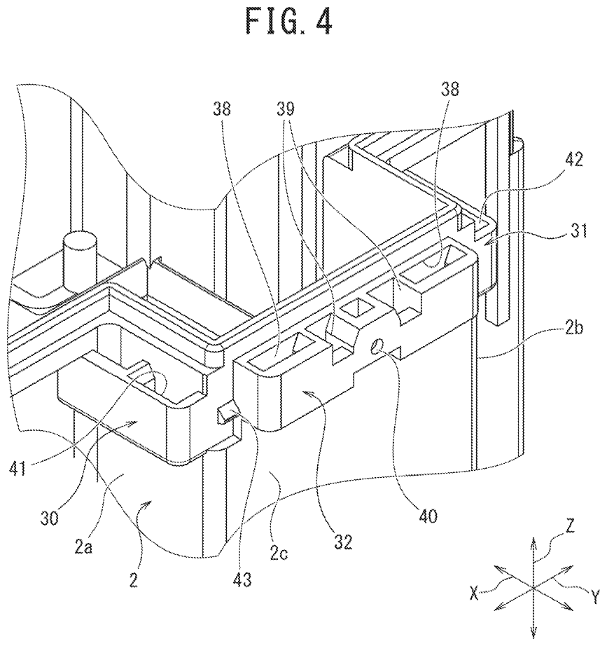

As illustrated in FIG. 4, in the first frame fixing member 32 there are formed a pair of insertion sections 38 penetrating in the Z-direction while separated from each other in the Y-direction, and between the pair of insertion sections 38 there are formed a pair of insertion sections 39 penetrating in the Z-direction while separated from each other in the Y-direction. In an outer wall facing one side in the X direction of the first frame fixing member 32 is formed a connecting recess 40. As illustrated in FIG. 3A, in the first frame fixing member 30 is formed an insertion section 41 penetrating in the Z-direction, and as illustrated in FIG. 3B, in the first frame fixing member 31 is formed an insertion section 42 penetrating in the Z-direction.

As illustrated in FIG. 3A, on a bulging wall 2c of the first frame 2, a projection engaging member 43 projecting toward one side in the X-direction is formed on one side in the Y-direction with respect to the first frame fixing member 32, and as illustrated in FIG. 3B, a projection engaging member 44 projecting toward one side in the X-direction is formed on the other side in the Y-direction with respect to the first frame fixing member 32.

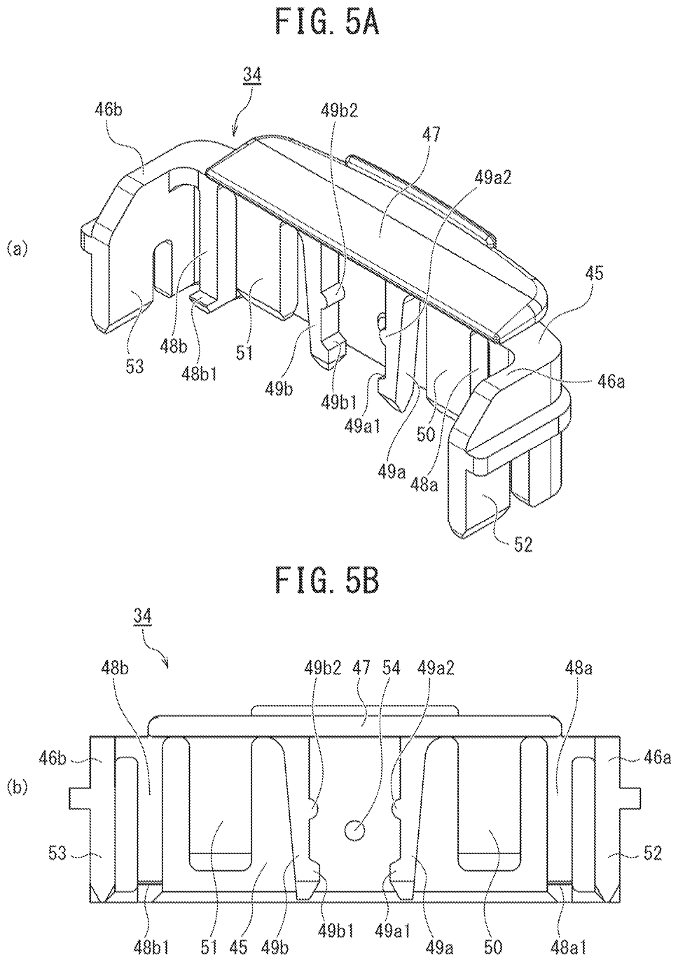

As illustrated in FIG. 5A, the connecting member 34 is formed in a U-shape by a long-length main plate 45 and a pair of end plates 46a, 46b extending parallel to each other from both longitudinal ends of the main plate 45, and a gripping member 47 is formed at one end in a short-length direction of the main plate 45.

As illustrated in FIG. 5B, the connecting member 34 includes a pair of positioning members 48a, 48b extending along the pair of end plates 46a, 46b at both longitudinal ends of the main plate 45, and claw-shaped stopper projections 48a1 and 48b1 are formed at the tip of the positioning members 48a, 48b. At the center between the pair of positioning members 48a, 48b there are formed a pair of flexible arms 49a, 49b with its base member fixed to the gripping member 47 and extending in a direction away from the gripping member 47 along the main plate 45. At the tip of the pair of flexible arms 49a, 49b there are formed first locking projections 49a1, 49b1 bulging in a mutually approaching direction, and also at the base member there are formed second locking projections 49a2, 49b2 bulging in a mutually approaching direction.

Between one positioning member 48a and one flexible arm 49a there is formed a plate-shaped insertion piece 50 with its base member fixed to the gripping member 47 and extending in a direction away from the gripping member 47 along the main plate 45. Also between the other positioning member 48b and the other flexible arm 49b there is formed a plate-shaped insertion piece 51 with its base member fixed to the gripping member 47 and extending in a direction away from the gripping member 47 along the main plate 45. Also on the pair of end plates 46a, 46b there are formed plate-shaped insertion pieces 52, 53 extending with their surface direction orthogonal to the insertion pieces 50, 51 described above. Here, on an inner wall of the central member in the longitudinal direction of the main plate 45, there is formed a hemispherical click projection 54 engaging with the connecting recess 40 formed in the first frame fixing member 32 of the first frame 2 or with the temporarily holding recess 37 formed in the second frame fixing member 33 of the second frame 3.

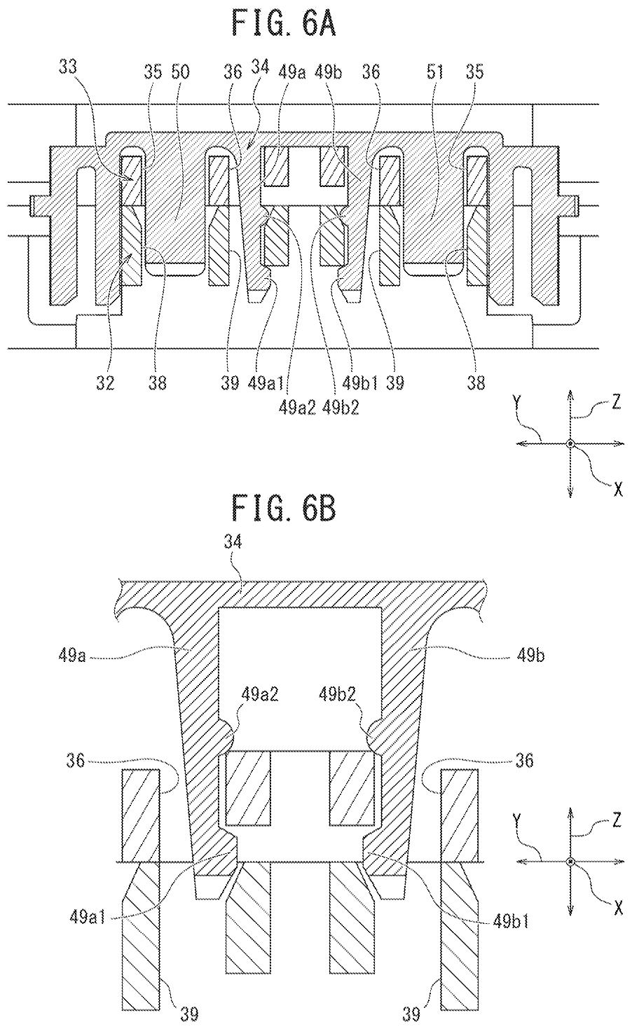

Here, FIG. 6A, 7, 8A and 9A illustrate a state in which the connecting member 34 constituting the relative displacement suppression mechanism 6 is mounted inside the first frame fixing members 30 to 32 of the first frame 2 and the second frame fixing member 33 of the second frame 3. This state is referred to as the connected state of the connecting member 34 in the following description.

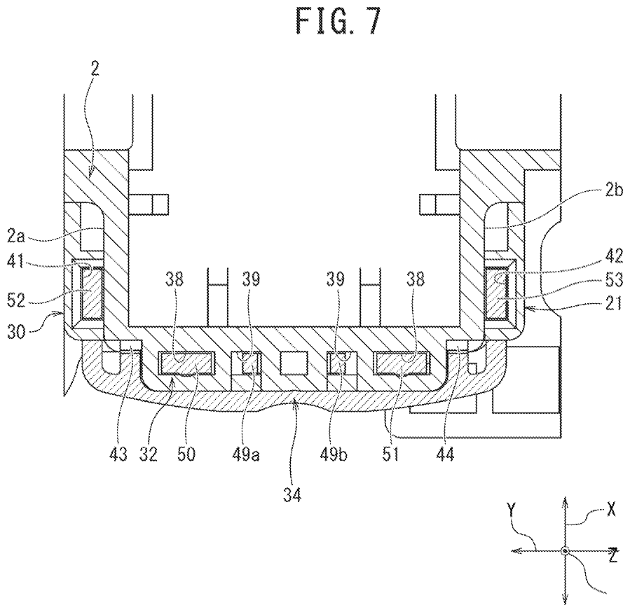

In the connected state of the connecting member 34, as illustrated in FIG. 6A, the insertion pieces 50, 51 of the connecting member 34 are inserted into the pair of insertion sections 38 of the first frame fixing member 32 and into the pair of insertion sections 35 of the second frame fixing member 33. The first locking projections 49a1, 49b1 of the pair of flexible arms 49a, 49b of the connecting member 34 pass through the insertion section 36 while being elastically deformed and engage with the opening periphery of the first frame insertion section 39. Further, as illustrated in FIG. 7, the insertion piece 52 of the connecting member 34 is inserted into the insertion section 41, and the insertion piece 53 is inserted into the insertion section 42.

In the connected state of the connecting member 34, as illustrated in FIG. 7, a surface facing in the X-direction of the insertion pieces 50, 51 of the connecting member 34 abuts on an inner wall facing in the X-direction of the pair of insertion sections 38, a surface facing in the Y-direction of the insertion pieces 50, 51 abuts on an inner wall facing in the Y-direction of the pair of insertion sections 38, a surface facing in the X-direction of the insertion pieces 50, 51 abuts on an inner wall facing in the X-direction of the pair of insertion sections 35, and a surface facing in the Y-direction of the insertion pieces 50, 51 abuts on an inner wall facing in the Y-direction of the pair of insertion sections 35, thus allowing suppression of relative displacement in the X-direction and the Y-direction of the first frame 2 and the second frame 3. In the connected state of the connecting member 34, as illustrated in FIG. 7, a surface facing in the Y-direction of the insertion pieces 52, 53 of the connecting member 34 abuts on an inner wall facing in the Y-direction of the insertion sections 41, 42, and a surface facing in the X-direction of the insertion pieces 52, 53 abuts on an inner wall facing in the X-direction of the insertion sections 41, 42, thus allowing suppression of relative displacement in the X-direction and the Y-direction of the first frame 2 and the second frame 3.

In addition, as illustrated in FIGS. 6A and 6B, since the first locking projections 49a1, 49b1 of the pair of flexible arms 49a, 49b of the connecting member 34 are engaged with the opening periphery of the insertion section 39 of the first frame 2, relative displacement in the Z-direction of the connecting member 34 is also suppressed.

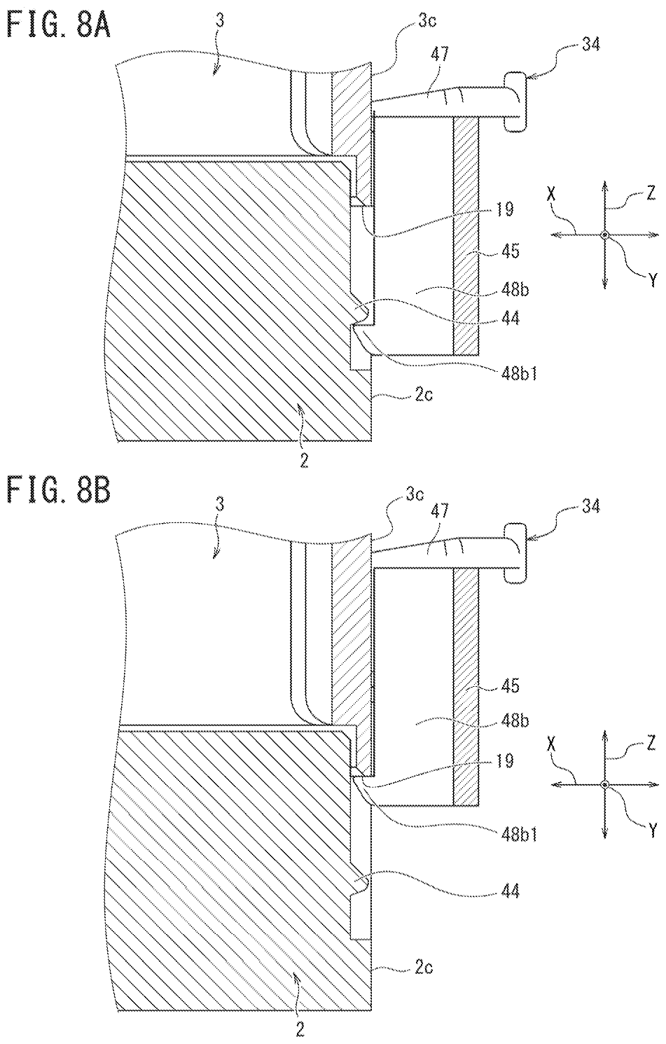

Also, as illustrated in FIG. 8A, in the connected state of the connecting member 34, the stopper projection 48b1 of the connecting member 34 engages over the projection engaging member 44 formed on the first frame 2 while the connecting member 34 is mounted. Although not illustrated, the stopper projection 48a1 of the connecting member 34 also engages over the projection engaging member 43 formed on the first frame 2 while the connecting member 34 is mounted. Accordingly, even when an external force such as vibration is transmitted to the connecting member 34, the stopper projections 48a1, 48b1 stay engaged with the projection engaging members 43, 44 thus preventing the connecting member 34 from falling off.

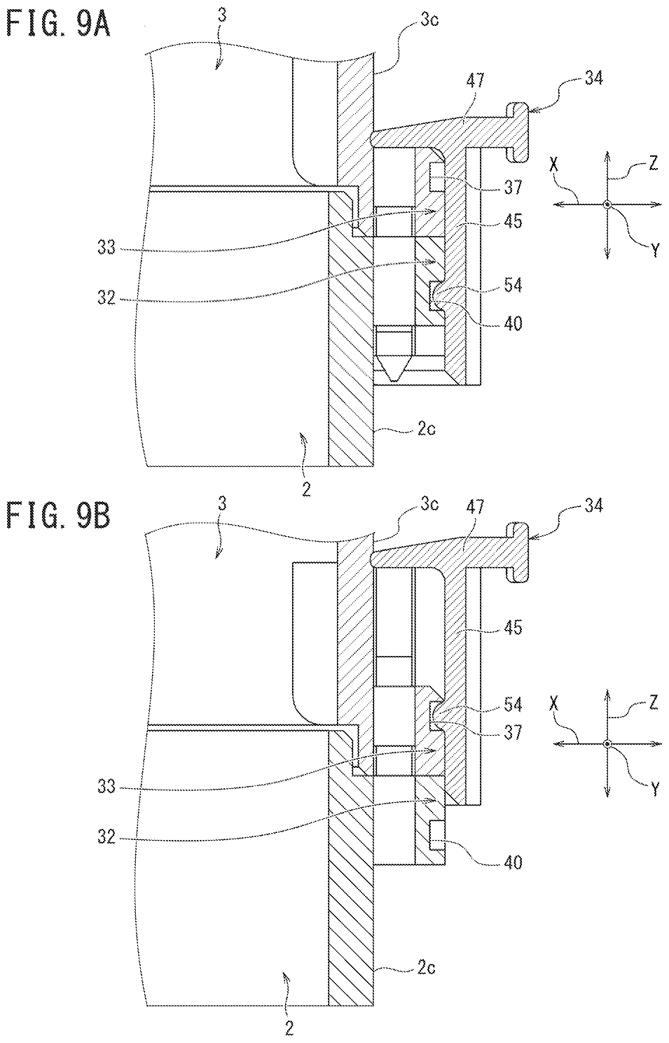

Further, as illustrated in FIG. 9A, in the connected state of the connecting member 34, since the click projection 54 formed on the main plate 45 of the connecting member 34 enters to engage with the connecting recess 40 formed in the first frame fixing member 32 of the first frame 2, the connecting member 34 is prevented from falling off even when an external force such as vibration is transmitted to the connecting member 34.

Next, FIGS. 6B, 8B and 9B illustrate a state in which the connecting member 34 of the relative displacement suppression mechanism 6 is temporarily held by the second frame 3. This state is referred to as the temporarily held state of the connecting member 34 in the following description.

In the temporarily held state of the connecting member 34, the insertion pieces 50, 51, 52, 53 of the connecting member 34 exits from the inside of the first frame fixing members 30 to 32, and as illustrated in FIG. 6B, the second locking projections 49a2, 49b2 engage with the opening periphery of the insertion section 36 of the second frame 3 byway of an elastic return force of the pair of flexible arms 49a, 49b of the connecting member 34. This prevents the connecting member 34 from returning upward in the Z-direction in FIG. 6B due to gravity or the like.

In addition, as illustrated in FIG. 8B, in the temporarily held state of the connecting member 34, the stopper projection 48b1 of the connecting member 34 engages with the stopper member 19 provided on the bulging wall 3c of the second frame 3. Although not illustrated, in the temporarily held state of the connecting member 34, the stopper projection 48a1 of the connecting member 34 also engages with the stopper member 19 provided on the bulging wall 3c of the second frame 3. As illustrated in FIG. 9B, in the temporarily held state of the connecting member 34, the click projection 54 of the connecting member 34 enters and engages with the temporarily holding recess 37 formed in the second frame fixing member 33 of the second frame 3. In this way, in the temporarily held state of the connecting member 34, the stopper projections 48a1, 48b1 of the connecting member 34 engage with the stopper member 19 of the second frame 3, and the click projection 54 of the connecting member 34 engages with the temporarily holding recess 37 of the second frame 3, and as a result, the connecting member 34 does not fall off the second frame 3.

As an operator grasps and manipulates the gripping member 47 of the connecting member 34 to place the connecting member 34 from the temporarily held state into the connected state (operation from FIG. 9B to FIG. 9A), a click sound is generated when the click projection 54 of the connecting member 34 enters the connecting recess 40. Also, as in the operation from FIG. 8B to FIG. 8A, a click sound is generated when the stopper projections 48a1, 48b1 ride over the projection engaging members 43, 44. The operator, on hearing this click sound, can make sure that the connecting member 34 has successfully entered the connected state.

When the operator grasps and manipulates the gripping member 47 of the connecting member 34 to place the connecting member 34 from the connected state into the temporarily held state (operation from FIG. 9A to FIG. 9B), since a click sound is generated when the click projection 54 of the connecting member 34 enters the temporarily holding recess 37, the operator, on hearing the click sound, can make sure that the connecting member 34 has successfully entered the temporarily held state.

Effects of the present embodiment will now be described.

The electromagnetic contactor 1 of the present embodiment includes the relative displacement suppression mechanism 6 configured to suppress relative displacement of the first frame 2 and the second frame 3 connected together constituting the body frame 4. The relative displacement suppression mechanism 6 is configured to suppress and release relative displacement of the first frame 2 and the second frame 3 without using a tool, and accordingly, any component of the electromagnet unit 11 housed in the body frame 4, such as the electromagnetic coil 22, can be easily replaced with spare.

Since the relative displacement suppression mechanism 6 of the present embodiment is configured to reliably suppress relative displacement of the first frame 2 and the second frame 3 connected together, it is possible to provide the highly reliable electromagnetic contactor 1.

On the bulging wall member 18a of the first frame 2 of the relative displacement suppression mechanism 6 there is formed the first frame fixing member 32 extending in the Y-direction and the pair of first frame fixing members 30, 31 extending in the X-direction opposite to each other in the Y-direction, and on the bulging wall member 18b of the second frame 3 of the relative displacement suppression mechanism 6 there is formed the second frame fixing member 33 extending in the Y-direction overlapping the first frame fixing member 32 from the Z-direction. With the insertion pieces 50, 51 of the connecting member 34 inserted into the insertion section 35 of the second frame fixing member 33 and into the insertion section 38 of the first frame fixing member 32, and with the insertion pieces 52, 53 of the connecting member 34 inserted into the insertion sections 41, 42 of the pair of first frame fixing members 30, 31, the relative displacement suppression mechanism mounts the connecting member 34 across the bulging wall member 18a of the first frame 2 and the bulging wall member 18b of the second frame 3. This allows the relative displacement suppression mechanism 6 to reliably suppress relative displacement, in the X- and Y-directions, of the first frame 2 and the second frame 3 connected together.

In addition, the relative displacement suppression mechanism 6 is capable of holding the connected state of the connecting member 34 with respect to the first frame fixing members 30 to 32 and the second frame fixing member 33 when the first locking projections 49a1, 49b1 engages with the opening periphery of the insertion section 39 of the first frame fixing member 32 by way of the elastic return force of the flexible arms 49a, 49b of the connecting member 34.

In the temporarily held state of the connecting member 34, the stopper projections 48a1, 48b1 of the connecting member 34 engage with the stopper member 19 of the second frame 3, and the click projection 54 of the connecting member 34 enters the temporarily holding recess 37 of the second frame 3, thus reliably preventing the connecting member 34 from falling from the second frame 3.

Further, as an operator grasps and manipulates the gripping member 47 of the connecting member 34 to place the connecting member 34 from the temporarily held state into the connected state, a click sound is generated when the click projection 54 of the connecting member 34 enters the connecting recess 40, and also when the stopper projections 48a1, 48b1 ride over the projection engaging members 43, 44, and accordingly the operator can easily make sure that the connecting member 34 has successfully entered the connected state. As the operator manipulates the connecting member 34 to place the connecting member 34 from the connected state into the temporarily held state, a click sound is generated when the click projection 54 enters the temporarily holding recess 37, and accordingly the operator can easily make sure that the connecting member 34 has successfully entered the temporarily held state. Therefore, since the click sound is generated when the connecting member 34 is placed into the temporarily held state or into the connected state, it is possible to give a sufficient click feel to the operator.

In the embodiment described above, while the pair of first frame fixing members 30, 31 extending in the X-direction opposite to each other in the Y-direction are formed as members constituting the relative displacement suppression mechanism 6, the subject matter of the present invention is not limited to this structure but a structure in which only one of the pair of first frame fixing members 30, 31 is formed and one of the insertion pieces 52, 53 of the connecting member 34 is inserted can achieve the same effect.

While the pair of insertion pieces 50, 51 are formed on the connecting member 34 and two insertion sections 35, 38 are formed in the first frame fixing member 32 and the second frame fixing member 33 into which the pair of insertion pieces 50, 51 are inserted, the subject matter of the present invention is not limited to this configuration but a structure in which a single insertion piece is formed on the connecting member 34 ands single insertion section is formed in the first frame fixing member 32 and the second frame fixing member 33 the first frame fixing member 32 and the second frame fixing member 33 can achieve the same effect.

### REFERENCE SIGNS LIST

1 Electromagnetic contactor
2 First frame
2a, 2b Bulging wall (first bulging wall)
2c Bulging wall (second bulging wall)
3 Second frame
20 3a, 3b Bulging wall (first bulging wall)
3c Bulging wall (second bulging wall)
4 Body frame
5 Snap-fit mechanism
6 Relative displacement suppression mechanism
7 Mounting plate member
8 Primary side terminal member
9 Secondary side terminal member
10 Contact unit
11 Electromagnet unit
12, 13 Fixed contact piece
14 Movable contact piece
15 Movable contact support
16 Fitting hole
17 Fitting projection
18 Bulging wall member
18a, 18b Bulging wall member
19 Stopper member
20 Fixed iron core
21 Movable iron core
22 Electromagnetic coil
23 Return spring
24 Winding
25 Bobbin
30, 31 First frame fixing member (third fixing member)
32 First frame fixing member (first fixing member)
33 Second frame fixing member (second fixing member)
34 Connecting member
35 Insertion section (first insertion section)
36 Insertion section (third insertion section)
37 Temporarily holding recess (recess)
38 Insertion section (first insertion section)
39 Insertion section (third insertion section)
40 Connecting recess (recess)
41, 42 Insertion section (second insertion section)
43, 44 Projection engaging member
45 Main plate
46a, 46b End plate
47 Gripping member
48a, 48b Positioning member
48a1, 48b1 Stopper projection
49a, 49b Flexible arm
49a1, 49b1 First locking projection
49a2, 49b2 Second locking projection
50, 51 Insertion piece (first insertion piece)
52, 53 Insertion piece (second insertion piece)
54 Click projection

1. An electric device comprising:
a first frame and a second frame each configured to house one or more electric components by arranging an open end of each of the frames opposed to each other in a first direction; and
a relative displacement suppression mechanism configured to detachably connect together the first frame and the second frame, to suppress relative displacement to a second direction and a third direction orthogonal to the first direction and orthogonal to each other in the same plane;
wherein on each of the first frame and the second frame there are arranged, as opposed to each other, a pair of first bulging walls extending in the second direction with a wall surface oriented backwards to each other in the third direction, and bulging wall members having a second bulging wall with a wall surface oriented in the second direction at the tip of the pair of first bulging walls, and
the relative displacement suppression mechanism comprises: a first fixing member formed on the second bulging wall of the first frame; a second fixing member formed on the second bulging member of the second frame overlapping the first fixing member in the first direction; a third fixing member formed on at least one of the pair of first bulging walls of the first frame; and a connecting member configured to engage with the first to third fixing members by moving from the second frame side to the first frame side.

2. The electric device according to claim 1, wherein the relative displacement suppression mechanism has:
a connected state in which the connecting member is connected to all of the first to third fixing members to suppress relative displacement to the second direction and the third direction; and
a temporarily held state in which the connecting member is engaged with only the second fixing member of the second frame to release relative displacement to the second direction and the third direction and temporarily hold the connecting member.

3. The electric device according to claim 2, wherein on the first fixing member and the second fixing member overlapping each other in the first direction there is formed first insertion sections arranged in the same position in the second direction and the third direction and extending in the first direction, wherein on the third fixing member there is formed a second insertion section extending in the first direction,
the connecting member comprises a first insertion piece to be inserted into the first insertion section and a second insertion piece to be inserted into the second insertion section, and the first insertion piece and the second insertion piece suppress relative displacement of the first frame and the second frame in the second direction and the third direction to place the connecting member into the connected state.

4. The electric device according to claim 2, wherein the connecting member comprises a flexible arm having a first locking projection formed at its tip,
in the first fixing member and the second fixing member overlapping each other in the first direction there is formed a third insertion section configured to insert the flexible arm there-through, and
in the connected state the first locking projection engages with the third insertion section byway of an elastic return force of the flexible arm to maintain the connected state.

5. The electric device according to claim 2, wherein on the connecting member there is formed a stopper projection projecting toward the bulging wall member of the first frame and the second frame,
in the connected state the stopper projection engages with a projection engaging member formed on the first frame to maintain the connected state,
in the temporarily held state the stopper projection riding over the projection engaging member engages with a stopper member provided on the second frame to prevent the connecting member from falling off the second frame.

6. The electric device according to claim 2, the electric device comprising a click sound generating means to generate a click sound when the connecting member moves between the connected state and the temporarily held state.

7. The electric device according to claim 6, wherein in the click sound generating means there is formed a click projection on one of the first fixing member and the second fixing member, and the connecting member, and there is formed a recess in the other, and
a click sound is generated when the connecting member moves between the first fixing member and the second fixing member to allow the click projection to enter the recess. 8. The electric device according to claim 1, wherein the electric components are a contact unit and an electromagnet unit configured to drive the contact unit.

9. The electric device according to claim 3, wherein the connecting member comprises a flexible arm having a first locking projection formed at its tip,
in the first fixing member and the second fixing member overlapping each other in the first direction there is formed a third insertion section configured to insert the flexible arm there-through, and
in the connected state the first locking projection engages with the third insertion section byway of an elastic return force of the flexible arm to maintain the connected state.

10. The electric device according to claim 3, wherein on the connecting member there is formed a stopper projection projecting toward the bulging wall member of the first frame and the second frame,
in the connected state the stopper projection engages with a projection engaging member formed on the first frame to maintain the connected state,
in the temporarily held state the stopper projection riding over the projection engaging member engages with a stopper member provided on the second frame to prevent the connecting member from falling off the second frame.

11. The electric device according to claim 4, wherein on the connecting member there is formed a stopper projection projecting toward the bulging wall member of the first frame and the second frame,
in the connected state the stopper projection engages with a projection engaging member formed on the first frame to maintain the connected state,
in the temporarily held state the stopper projection riding over the projection engaging member engages with a stopper member provided on the second frame to prevent the connecting member from falling off the second frame.

12. The electric device according to claim 3, the electric device comprising a click sound generating means to generate a click sound when the connecting member moves between the connected state and the temporarily held state.

13. The electric device according to claim 4, the electric device comprising a click sound generating means to generate a click sound when the connecting member moves between the connected state and the temporarily held state.

14. The electric device according to claim 5, the electric device comprising a click sound generating means to generate a click sound when the connecting member moves between the connected state and the temporarily held state.

15. The electric device according to claim 2, wherein the electric components are a contact unit and an electromagnet unit configured to drive the contact unit. 16. The electric device according to claim 3, wherein the electric components are a contact unit and an electromagnet unit configured to drive the contact unit.

17. The electric device according to claim 4, wherein the electric components are a contact unit and an electromagnet unit configured to drive the contact unit.

18. The electric device according to claim 5, wherein the electric components are a contact unit and an electromagnet unit configured to drive the contact unit.

19. The electric device according to claim 6, wherein the electric components are a contact unit and an electromagnet unit configured to drive the contact unit.

20. The electric device according to claim 7, wherein the electric components are a contact unit and an electromagnet unit configured to drive the contact unit.
